(19) United States
(12) Patent Application Publication
(10) Pub. No.: US 2026/0312942 A1
(43) Pub. Date: Oct. 8, 2026

(54) ARCHIVAL MESSAGE CONTENT INSPECTION FOR ENCRYPTED MESSAGING SYSTEMS AND APPLICATIONS

(71) Applicant: T-MOBILE INNOVATIONS LLC, Overland Park, KS (US)

(72) Inventor: Mark Daniel ALLEN, Renton, WA (US)

(21) Appl. No.: 19/173,574

(22) Filed: Apr. 8, 2025

(51) Int. Cl. H04L 9/40

(52) U.S. Cl. CPC H04L 63/0428

(57) ABSTRACT

In various examples, archival message content inspection for encrypted messaging systems and applications are provided. An internal archiving platform may simulate a primary message archiving platform endpoint for receiving deposits of transmitted message data. As an authorized endpoint, the internal archiving platform can decrypt the data, granting access to the original message payload using the same credentials and protocols as a primary message archiving platform. This access allows for troubleshooting of specific formatting issues or changes that are otherwise hidden by encryption. By selectively depositing transmitted message data in the internal archiving platform, the messaging system developers can analyze the content and identify discrepancies or errors. Activation of the internal archiving platform may involve updating the subscriber archiving profile with an inspection indicator, which directs the message archival routing server to route a copy of the transmitted message data to the internal archiving platform for inspection and archiving.

### BACKGROUND

Message archival services are services that may be provided by an internet protocol (IP)-based messaging service (e.g., an instant message service) to help organizations meet regulatory compliance and legal requirements and/or assist in troubleshooting tasks. Such message archival services aim to ensure that all communications carried by the messaging service (e.g., text messages (short message service (SMS)/multimedia messaging service (MMS)), rich communication services (RCS), etc.) are securely stored and can be retrieved when needed. The ability to access message archives is particularly important for industries where regulations mandate the retention and accessibility of communication records. Currently, the content of these messages is encrypted, and may not be logged by the message originator for security reasons, making it difficult to identify and access the content of messages sent by a message originator to the message target (e.g., the intended message recipient).

### SUMMARY

This summary is provided to introduce a selection of concepts in a simplified form that are further described below in the detailed description. This summary is not intended to identify key features or essential features of the claimed subject matter, nor is it intended to be used in isolation as an aid in determining the scope of the claimed subject matter.

In contrast to prior solutions, one or more of the embodiments presented herein provide for an internal archiving platform that simulates a primary message archiving platform endpoint for receiving deposits of transmitted message data. As an authorized endpoint for the transmitted message data, the internal archiving platform is able to decrypt the transmitted message data to provide the messaging service platform developers and system administrators with access to the original message payload using the same credentials and protocol as the primary message archiving platform would use to receive and archive the transmitted message data. This access allows for messaging service platform developers and system administrators to obtain insight into specific formatting issues or changes that would otherwise be hidden by encryption, and conduct the applicable troubleshooting to address those issues. By selectively depositing transmitted message data in the internal archiving platform, the messaging service platform personnel can analyze the content and identify any discrepancies or errors that may be occurring.

In some embodiments, in order to activate the internal archiving platform, the subscriber archiving profile associated with a subscriber identifier (ID) may be updated to include an inspection indicator. For example, the inclusion of an inspection indicator in the subscriber archiving profile may indicate that internal logging is activated for that subscriber ID, and that an internal archiving platform is designated an additional terminal endpoint that is to receive transmitted message data deposits. For example, the inspection indicator may comprise a flag or tag indicating that internal logging is active and that the message archival routing server is to route a copy of the transmitted message data to a default internal archiving platform for archiving. In some embodiments, the inspection indicator may comprise a partner ID (e.g., a special inspection partner ID) associated with the internal archiving platform so that the message archival routing server may route the copy of the transmitted message data to a network address associated with the partner ID-thus responding to the inclusion of the partner ID for the internal archiving platform in the same way as it would respond to the inclusion of a partner ID for any other primary message archiving platform. That is, in this transmission from the message originator (MO) to the internal archiving platform (via the message archival routing server), each of the MO and the internal archiving platform represents an endpoint of the message transmission with end-to-end encryption and authentication protocols (e.g., SSL, TLS, and mTLS) applied between those endpoints. As an authorized endpoint for the transmitted message data, the internal archiving platform is able to decrypt and inspect the message content payload of the transmitted message data to provide the messaging service platform developers and system administrators with access to the original message payload using the same credentials and protocol as any other primary message archiving platform would use to receive and archive the transmitted message data.

### BRIEF DESCRIPTION OF THE DRAWINGS

Aspects of the present disclosure are described in detail herein with reference to the attached Figures, which are intended to be exemplary and non-limiting, wherein:

FIG. 1 is a diagram illustrating an example network operating environment for a network-based messaging system, in accordance with some embodiments;

FIG. 2 is a diagram illustrating an example data flow between a message archival routing server and a message subscriber database that includes one or more subscriber archiving profiles, in accordance with some embodiments;

FIG. 3 is a diagram for an example data flow for an example internal archiving platform, in accordance with some embodiments;

FIGS. 4 and 5 are example data flow diagrams illustrating archival message data routing, in accordance with some embodiments;

FIG. 6 is a diagram illustrating an example telecommunications network environment comprising network functions for implementing an archiving messaging service, in accordance with some embodiments;

FIG. 7 is a flow chart illustrating an example method for archival message content inspection for encrypted messaging, according to some embodiments;

FIG. 8 is a diagram illustrating an example computing environment, in accordance with one embodiment; and

FIG. 9 is a diagram illustrating an example cloud computing environment, in accordance with some embodiments.

### DETAILED DESCRIPTION

Embodiments of the present disclosure provide for archival message content inspection for encrypted messaging systems and applications.

As the use of Message Archival services expands due to increasing compliance requirements for businesses, government agencies, and other entities, there is a growing need for solutions that ensure content consistency and quality when pushing messages from a messaging service platform (e.g., a mobile carrier) to third-party partner storage endpoints for archival purposes. For example, when a message originator (MO) transmits a message to a message target (MT) endpoint, a copy of the message may be deposited by the IMS to a third-party partner storage endpoint. The content of these messages is encrypted such that only authorized endpoints receiving the message may decrypt the message to access the original content payload. The encryption and security enforcements in place mean that the messaging service platform developers and system administrators cannot see the actual content of the messages being sent.

The inability for messaging service platform developers and system administrators to access the actual content of the messages presents a significant challenge with respect to troubleshooting scenarios where an otherwise authorized endpoint is unable to intelligently parse the message content of a received message, for example due to message formatting errors. That is, despite the transmission to the endpoint succeeding and the messaging service platform receiving a positive acknowledgment in response, an endpoint receiving a message may struggle to process the content correctly due to differences between the format of the message as received, and the expected format of the message, which may arise during the message creation and/or transmission process. These issues can stem from changes within the network or modifications made by third parties, such as peering partners, before the messages are encrypted and sent to the target recipient. For example, additional new lines or characters may be introduced into the content, which can disrupt the expected format and/or order of data carried by a message, resulting in ingestion problems at the partner endpoint. Without visibility into the raw data format, it is impossible for a messaging service platform provider to ensure that the content being sent adheres to the expected format, which can lead to problems at the partner endpoint—which can significantly impact the partner's ability to correctly ingest and process the information after decryption.

Several solutions have been attempted to address the challenges of message archival and content inspection. One approach involves messaging servers logging the pre-encrypted content locally as the message is sent from the MO to the MT. This method allows for the inspection of user content stored locally. Another method involves message traffic inspection on the communication channel between the IMS provider's servers and the endpoint servers using transport security protocols that allow for the capture and decryption of captured traffic. However, with the evolution of cybersecurity, these solutions are no longer considered acceptable practices. Modern platforms cannot log user content and store it locally due to stringent security requirements, making this approach obsolete. Similarly, end-to-end security protocols now in place prevent the capture and decryption of mid-stream captured traffic, rendering such solutions similarly impractical.

In contrast to prior solutions, embodiments of the present disclosure may establish an internal archiving platform that simulates a primary message archiving platform endpoint for receiving deposits of transmitted message data. As an authorized endpoint for the transmitted message data, the internal archiving platform is able to decrypt the transmitted message data to provide the messaging service platform developers and system administrators with access to the original message payload using the same credentials and protocol as the primary message archiving platform would use to receive and archive the transmitted message data. This access allows for messaging service platform developers and system administrators to obtain insight into specific formatting issues or changes that would otherwise be hidden by encryption, and conduct the applicable troubleshooting to address those issues. By selectively depositing transmitted message data in the internal archiving platform, the messaging service platform can analyze the content and identify any discrepancies or errors that may be occurring.

For example, in some embodiments, when an MO provisions a message for transmission to one or more MTs, an IP Multimedia Subsystem (IMS) core may transmit the message to a message routing server which may then route the message data via a network (e.g., the Internet) to the user equipment (UE) of the one or more MTs. In this transmission from the MO to the MT(s), each of the MO and the MT(s) represents an endpoint of the message transmission with end-to-end encryption and authentication protocols (e.g., secure sockets layer (SSL), transport layer security (TLS), and/or mutual transport layer security (mTLS)) applied between those endpoints. In some embodiments, routing of the transmitted message data to the MT(s) may be based on subscriber ID(s) (e.g., a phone number), where subscriber IDs may serve as a messaging network address associated with the UE of the MO and MT(s).

With respect to archiving that transmitted message data, in some embodiments, the IMS core may call on a message archival routing server to log the transmitted message data in accordance with a subscriber archiving profile associated with the MO. For example, the IMS core may send a copy of the transmitted message data (which carries the encrypted message content payload) to the message archival routing server, and the message archival routing server responds by performing a subscriber archiving profile query to a message subscriber database based on the subscriber ID of the MO. The message subscriber database may include one or more subscriber archiving profiles, where each profile includes one or more partner IDs (e.g., routing tags) that identify which primary message archiving platform(s) should be sent a copy of the transmitted message data, based on the subscriber ID of the MO. That is, the subscriber archiving profiles may be configured (e.g., on a per-subscriber basis) to implement a distributed delivery of transmitted message data to one or more archives based on the customer preferences. The message subscriber database may respond to the query with archive routing data (e.g., a partner ID, phone number, and/or other network address) of one or more primary message archiving platforms associated with the MO subscriber ID, and the message archival routing server may then route the copy of the transmitted message data via a network (e.g., the Internet) to the appropriate message archive partner(s) for archiving. In this transmission from the MO to the message archive partner(s) (via the message archival routing server), each of the MO and the message archive partner(s) represents an endpoint of the message transmission with end-to-end encryption and authentication protocols (e.g., SSL, TLS, and/or mTLS) applied between those endpoints. As such, the message archival routing server may route different transmitted message data to different message archive partner(s) based on the particular subscriber archiving profile associated with the subscriber ID of the MO. It should be understood that in some embodiments, the message archival routing server may similarly operate to send incoming transmitted message data addressed to the MO as a target recipient (e.g., reply messages) for deposit to message archive partner(s) based on partner ID data included in the subscriber archiving profiles.

In some embodiments, in order to activate the internal archiving platform, the subscriber archiving profile associated with a subscriber ID may be updated to include an inspection indicator. For example, the inclusion of an inspection indicator in the subscriber archiving profile may indicate that internal logging is activated for that subscriber ID, and that an internal archiving platform is designated an additional terminal endpoint that is to receive transmitted message data deposits. For example, the inspection indicator may comprise a flag or tag indicating that internal logging is active and that the message archival routing server is to route a copy of the transmitted message data to a default internal archiving platform for archiving. In some embodiments, the inspection indicator may comprise a partner ID (e.g., a special inspection partner ID) associated with the internal archiving platform so that the message archival routing server may route the copy of the transmitted message data to a network address associated with the partner ID—thus responding to the inclusion of the partner ID for the internal archiving platform in the same way as it would respond to the inclusion of a partner ID for any other primary message archiving platform. That is, in this transmission from the MO to the internal archiving platform (via the message archival routing server), each of the MO and the internal archiving platform represents an endpoint of the message transmission with end-to-end encryption and authentication protocols (e.g., SSL, TLS, and/or mTLS) applied between those endpoints. As an authorized endpoint for the transmitted message data, the internal archiving platform is able to decrypt and inspect the message content payload of the transmitted message data to provide the messaging service platform developers and system administrators with access to the original message payload using the same credentials and protocol as any other primary message archiving platform would use to receive and archive the transmitted message data. By selectively depositing transmitted message data in the internal archiving platform, the messaging service platform can analyze the content and identify any discrepancies or errors that may be occurring. The messaging service platform may thus selectively designate transmitted message data for internal logging while maintaining the integrity of the original encryption, message formatting, and/or message structure as it was received by the MT—which permits the messaging service platform developers and system administrators to use the functionality of the internal archiving platform to perform troubleshooting, and/or other network development-related tasks. The transmitted message data deposited to the internal archiving platform has traveled as traffic through essentially the exact same production environment used for depositing transmitted message data with the message archive partner(s)—providing very close visibility into exactly what these message archive partner(s) and/or customers of the messaging service are seeing—without compromising endpoint-to-endpoint security. Moreover, in some embodiments, activation of the internal archiving platform as an authorized endpoint may be performed by adding the inspection indicator to the subscriber archiving profile for a subscriber ID, and deactivation of the internal archiving platform as an endpoint may be performed by removing the inspection indicator to the subscriber archiving profile for a subscriber ID.

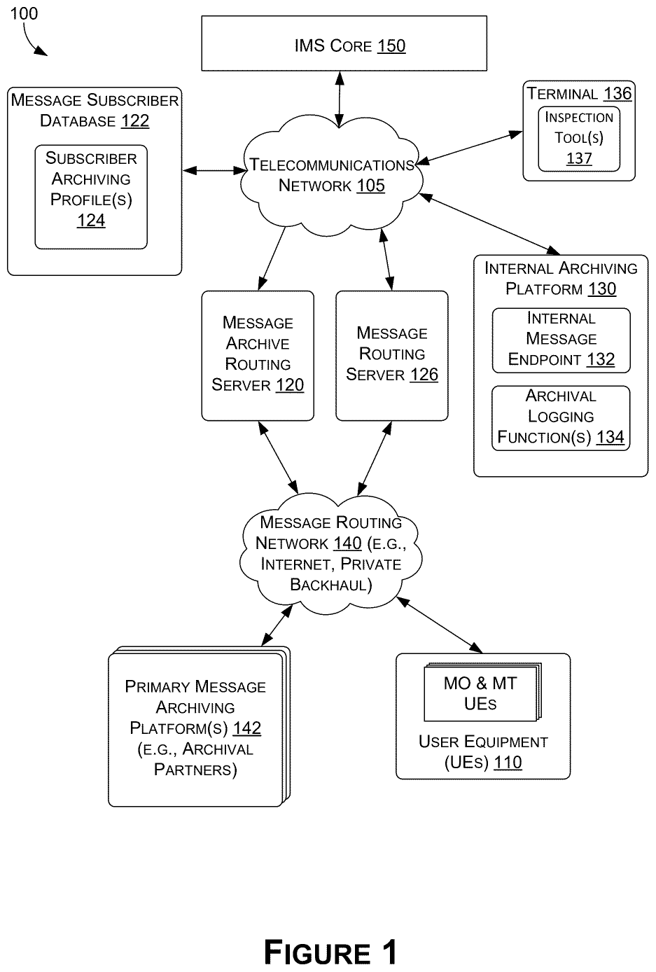

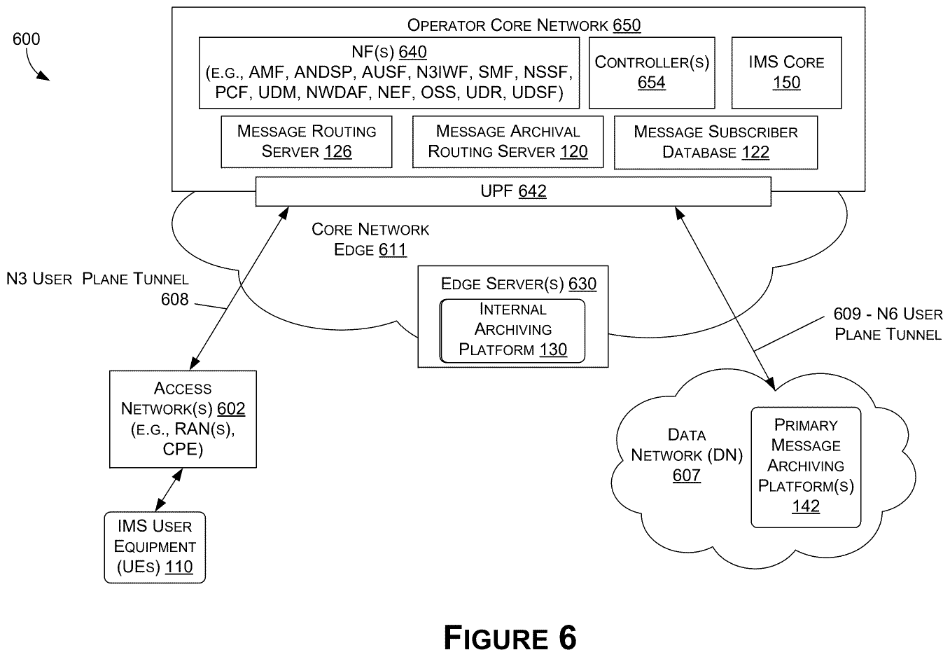

FIG. 1 is a diagram illustrating an example network operating environment 100, in accordance with some embodiments described herein. As shown in FIG. 1, operating environment 100 comprises an IP Multimedia Core Network Subsystem (IMS) core 150. In some embodiments, the IMS core 150 operates as a standardized architectural framework for a messaging system that facilitates the delivery of messages between an MO and one or more MOs over a network (e.g., IP networks such as the Internet). The IMS core 150 may manage session control, authentication, and authorization, enabling users to access messaging services (e.g., Short Message Service (SMS), Multimedia Messaging Service (MMS), Rich Communication Services (RCS), Unstructured Supplementary Service Data (USSD) and/or other message exchange services) securely and efficiently. The IMS core 150 may also support interoperability between various service providers (e.g., such as but not limited to the session initiation protocol (SIP), allowing for a consistent user experience regardless of the underlying network infrastructure. By leveraging protocols like SIP (Session Initiation Protocol), the IMS core 150 ensures robust and scalable communication, making it a vital element in modern telecommunications. In some embodiments, the IMS core 150 may be implemented as a component network function of a telecommunications network operator core network (CN) 650, such as is shown and discussed below with respect to FIG. 6. With respect to messaging services, the IMS core 150 may function to transmit messages from user equipment (UE) 110 operating as the MO to one or more message targets (MT) UE 110, operating as the MT(s).

For example, a UE 110 may comprise any form of computing device comprising such as, but not limited to, workstations, desktop computers, laptop computers, smart phones, tablets, handheld and/or wearable computing devices, personal digital assistants, a fitness tracker, or any other device capable of communicating using one or more resources of the IMS core 150. The terms “user equipment,” “UE,” and/or “user device” are used interchangeably to refer to a device employed by an end user that communicates using a network. UE(s) 110 may therefore include components such as software and hardware, one or more processors (e.g., processing circuitry), a memory, a display component, a power supply or power source, a speaker, a touch-input component, a keyboard, and the like.

As shown in FIG. 1, the IMS core 150 may be coupled to a telecommunications network 105 (which may comprise at least in part the CN 650 and or core network edge 611 as shown in FIG. 6) through which it communicates with one or more of a message routing server 126, a message archive routing server 120, a message subscriber database 122, an internal archiving platform 130, and/or a computing device 136 (e.g., a computer terminal 136). In some embodiments, the computing device 136 may run one or more inspection tools 137, for example for accessing functions of the IMS core 150, message routing server 126, message archive routing server 120, message subscriber database 122, internal archiving platform 130, and/or other network functions or network services. Inspection tools 137 may comprise one or more applications executed by the computing device 136 and/or one or more applications at least partially executed by cloud computing resources.

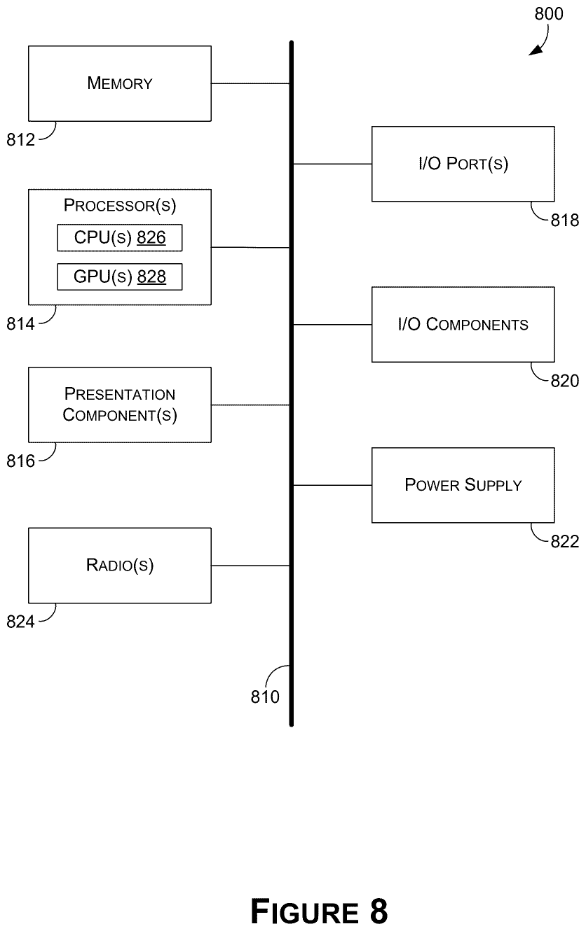

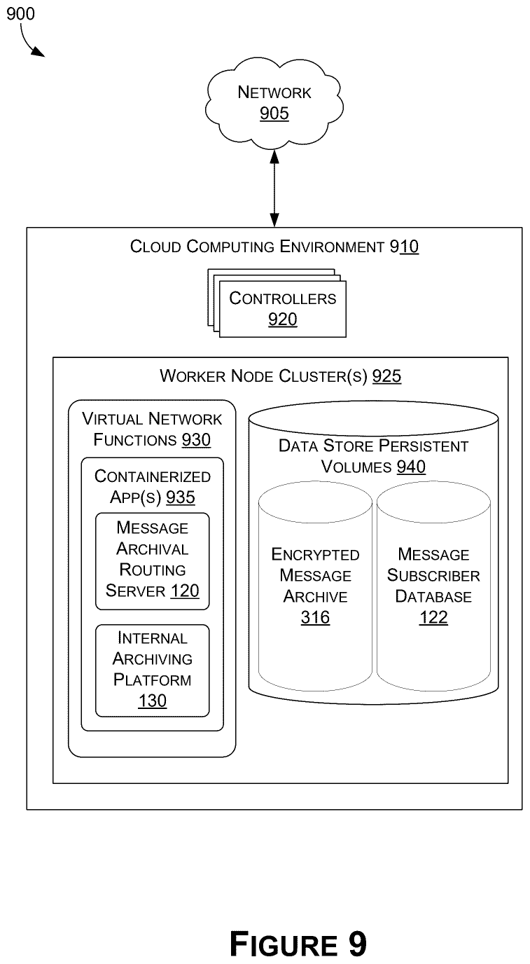

In some embodiments, the UE(s) 110 may comprise a wired or wireless network interface through which they communicate with the IMS core 150 through the message routing server 126, for example, via at least one message routing network 140. The at least one message routing network 140 may define a backhaul network, and may be implemented using one or more networks such as a cellular telecommunications network (e.g., a 4G LTE (4^{th} Generation—Long Term Evolution) and/or 5G NR (5^{th} Generation—New Radio) network), the Internet, one or more public backhaul network(s), and/or one or more proprietary backhaul network(s). In some embodiments, one or more primary message archiving platform(s) 142 may similarly communicate with the IMS core 150 through the message archive routing server 120, for example, via the at least one message routing network 140. In some embodiments, one or more functions of the IMS core 150, message routing server 126, a message archive routing server 120, a message subscriber database 122, an internal archiving platform 130, and/or computing device 136 may comprise and/or be at least partially implemented using code executed by the computing device 800 described with respect to FIG. 8, and/or components of the cloud computing platform 900 described with respect to FIG. 9.

When an MO provisions a message for transmission to an MT, the respective UE 110 of the MO encrypts the message content (e.g., using end-to-end encryption and authentication protocols (e.g., SSL, TLS, and/or mTLS) and transmits the encrypted message data to the IMS core 150. The transmitted message data may include the subscriber ID of the MO and may include the subscriber ID(s) of one or more MTs that are the intended recipient(s) of the message content. As previously mentioned, each of the MO and the MT(s) represent an endpoint of the message transmission with end-to-end encryption and authentication protocols applied between those endpoints. The IMS core 150 may forward the transmitted message data received from the MO to the message routing server 126, which may then route the transmitted message data via the message routing network 140 to the UE 110 of the one or more MTs. In some embodiments, routing of the transmitted message data to the UE 110 of the MT(s) may be based on subscriber ID(s) (e.g., a phone number), where subscriber IDs may serve as a messaging network address associated with the UE of the MO and MT(s). Replies (or other incoming messages) addressed for delivery to the MO may be similarly processed with the IMS core 150 receiving and forwarding the reply transmitted message data to the MO.

The primary message archiving platform(s) 142 shown in FIG. 1 may comprise one or more computing platforms (e.g., cloud-based network servers) that include message archiving service applications hosted by one or more network services, which may accept deposits of transmitted message data from the IMS core 150 (e.g., using one or more application programming interfaces (APIs) implemented by the primary message archiving platform(s) 142) for logging and/or archiving. In some embodiments, when the IMS core 150 receives transmitted message data received from the UE 110 of the MO (or conversely receives an incoming message targeting that UE 110 of the MO), the IMS core 150 may call on the message archive routing server 120 to route the transmitted message data to one or more of the primary message archiving platform(s) 142 in accordance with a subscriber archiving profile 124 that may, for example, be correlated with the MO based on a subscriber ID. In some embodiments, one or more functions of the primary message archiving platform(s) 142 may comprise and/or be at least partially implemented using code executed by a computing device 800 such as is described with respect to FIG. 8, and/or components of a cloud computing platform 900 such as is described with respect to FIG. 9.

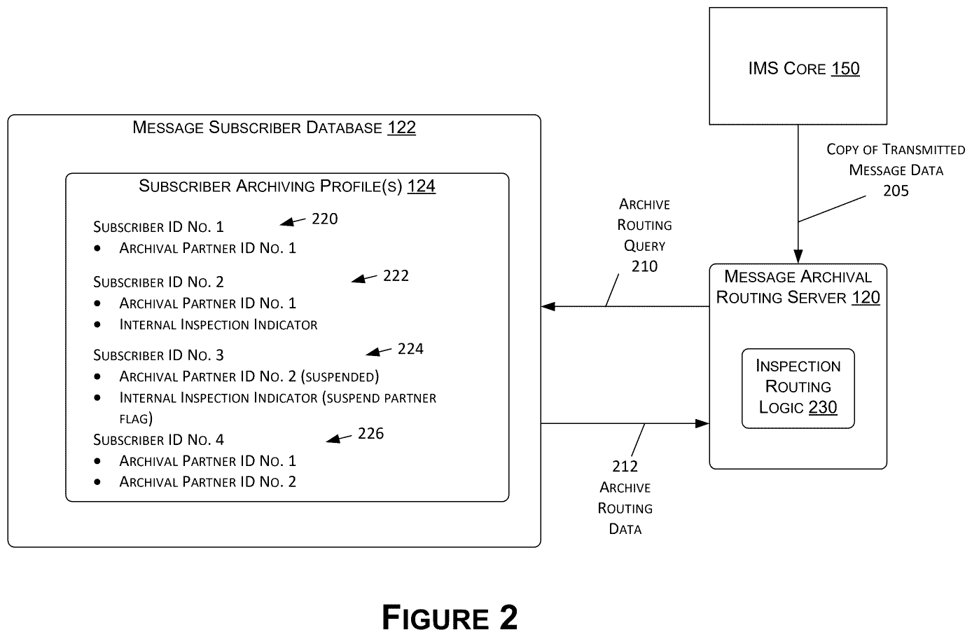

For example, as illustrated in FIG. 2, in some embodiments the IMS core 150 may send a message deposit request comprising a copy of the transmitted message data 205 (which carries the encrypted message content payload) to the message archive routing server 120. The message archive routing server 120 may respond to receiving the transmitted message data 205 by sending an archive routing query 210 to the message subscriber database 122 based on a subscriber ID (e.g., of the MO) included with the copy of the transmitted message data 205. The message subscriber database 122 may include one or more subscriber archiving profiles 124, as shown at 124. In some embodiments, the message subscriber database 122 may be integrated within the message archive routing server 120. As further discussed herein, a message archive routing server 120 may further include inspection routing logic 230 that reads the one or more subscriber archiving profiles 124 and configures the message archive routing server 120 to route the copy of the transmitted message data 205 to the internal archiving platform 130 based on when a subscriber archiving profiles 124 includes an internal inspection indicator.

In some embodiments, an individual subscriber archiving profile (shown by example at 220, 222, 224, and 226) may be defined for a subscriber ID that identifies one or more partner IDs corresponding to a respective primary message archiving platform 142 where a copy of the transmitted message data 205 should be deposited. For example, the subscriber archiving profile 220 indicates that transmitted message data 205 associated with subscriber ID No. 1 should be routed to the primary message archiving platform 142 that is assigned archival partner ID No. 1. Similarly, transmitted message data 205 associated with subscriber ID No. 4 should be routed to a first primary message archiving platform 142 that is assigned archival partner ID No. 1, and additionally routed to a second primary message archiving platform 142 that is assigned archival partner ID No. 2. The message subscriber database may respond to the query 210 by sending archive routing data 212 back to the message archive routing server 120. The archive routing data 212 may include, for example, a partner ID, phone number, and/or other network address indicating where the transmitted message data 205 is to be routed for archiving, and the message archive routing server 120 may then route the copy of the transmitted message data 205 via message routing network 140 to the appropriate message archive partner(s) 142 for archiving. In this transmission from the MO to the message archive partner(s) 142 indicated by the subscriber archiving profiles 124, each of the MO and the message archive partner(s) 142 represents an endpoint of the message transmission with end-to-end encryption and authentication protocols (e.g., SSL, TLS, and/or mTLS) applied between those endpoints. As such, the message archive routing server 120 may route different transmitted message data 205 to different message archive partner(s) 142 based on the particular subscriber archiving profile 124 associated with the subscriber ID of the MO and/or MT of the transmitted message data 205. That is, it should be understood that in some embodiments, the message archive routing server 120 may similarly operate to send incoming transmitted message data addressed to the MO as a target recipient (e.g., reply messages) for deposit to message archive partner(s) 142 based on partner ID data included in the subscriber archiving profiles 124.

In some embodiments, in order to deposit the transmitted message data 205 for a subscriber ID to the internal archiving platform 130, the subscriber archiving profile 124 associated with that subscriber ID may be updated (e.g., configured using inspection tool 137) to include an inspection indicator, as shown in FIG. 2 at 222 and 224. For example, in FIG. 2 the subscriber archiving profile 222 indicates that transmitted message data 205 associated with subscriber ID No. 2 should be routed to the primary message archiving platform 142 that is assigned archival partner ID No. 1, and includes an inspection indicator. The inspection routing logic 230 reads the subscriber archiving profile 222 and based on the inspection indicator, configures the message archive routing server 120 to additionally route the transmitted message data 205 to the internal archiving platform 130.

The subscriber archiving profile 224 for subscriber ID No. 3 also includes an inspection indicator, but in this case the inspection indicator may include a suspended partner flag. In this case, the inspection routing logic 230 may read the subscriber archiving profile 224 and based on the inspection indicator, configures the message archive routing server 120 to suspend routing transmitted message data 205 to the archival partner ID No. 2. As such, in this configuration, the subscriber archiving profile 224 causes the message archive routing server 120 to route the transmitted message data 205 to the internal archiving platform 130, but forgo depositing a copy with the primary message archiving platform 142 that is assigned archival partner ID No. 2. The ability to reconfigure the subscriber archiving profile 224 (e.g., which may be performed by inspection tool(s) 137) permits the operator of the messaging system to gain access to inspect the contents of transmitted message data 205 by inserting the inspection indicator—which functions to establish the internal archiving platform 130 as a simulated authorized endpoint for receiving the transmitted message data 205 and thus provides the ability to messaging service platform developers and system administrators to access the message content payload in an unencrypted form, without compromising existing end-to-end messaging security protocols that protect the transmitted message data 205 between the MO and MT(s) and/or the MO and primary message archiving platforms 142. By capturing the raw data of the message content, developers can analyze the content and identify any discrepancies or errors that may be occurring.

The message archive routing server 120 may thus respond to the inclusion of the inspection indicator in a subscriber archiving profile 124 by defining the internal archiving platform 130 as a terminal endpoint that is to receive a deposit of the transmitted message data. In some embodiments, the inspection routing logic 230 may read the subscriber archiving profile 224 and based on the presence of the inspection indicator, configure the message archival routing server 120 to route a copy of the transmitted message data to a default internal archiving platform 130 for archiving. In some embodiments, the inspection indicator may comprise a partner ID (e.g., a special inspection partner ID) associated with the internal archiving platform 130. The inspection routing logic 230 may read the subscriber archiving profile 224 may read the partner ID and based on the partner ID, configured the message archive routing server 120 to route the copy of the transmitted message data to a network address associated with the partner ID—thus responding to the inclusion of the partner ID for the internal archiving platform 130 in the same way as it would respond to the inclusion of a partner ID for any other primary message archiving platform 142. As discussed herein, when an inspection indicator is included in the subscriber archiving profile 124 for a subject ID, the profile may be configured to deposit the copy of transmitted message data 205 to both the normally designated primary message archiving platform 142 and the internal archiving platform 130, or to deposit the copy of transmitted message data 205 to the internal archiving platform 130 instead of the normally designated primary message archiving platform 142 (e.g., by flagging the partner ID for the normally designated primary message archiving platform 142 as suspended). By designating that the message archive routing server 120 should deposit the copy of transmitted message data 205 to the internal archiving platform 130, each of the MO and the internal archiving platform 130 represents an endpoint of the message transmission with end-to-end encryption and authentication protocols (e.g., SSL, TLS, and/or mTLS) applied between those endpoints. As an authorized endpoint for the transmitted message data, the internal archiving platform 130 is able to decrypt and inspect the message content payload of the transmitted message data to provide the messaging service platform developers and system administrators with access to the original message payload using the same credentials and protocol as any other primary message archiving platform 142 would use to receive and archive the copy of the transmitted message data 205. The transmitted message data deposited to the internal archiving platform 130 has traveled as traffic through a substantially similar path through the production environment as transmitted message data 205 deposited with the message archive partner(s) 142—providing very close visibility into exactly what these message archive partner(s) and/or customers of the messaging service are seeing—without compromising endpoint-to-endpoint security.

In some embodiments, the internal archiving platform 130 may include an internal message endpoint 132 that operates as an interface to receive the transmitted message data 205 from the message archive routing server 120, and one or more archival logging function(s) 134 that may be accessed by team members of the messaging service platform to evaluate the decrypted content of the transmitted message data 205 deposited to the internal archiving platform 130. For example, in some embodiments, an authorized staff member of the messaging service platform may use the computer terminal 136 (e.g., via inspection tools 137) to access one or more functions of the archival logging function(s) 134 to evaluate the message content of one or more copies of transmitted message data deposited to the internal archiving platform 130. The archival logging function(s) 134 may generate and output message inspection data to the IMS core 150 and/or inspection tools 137, the message inspection data based on a decryption of the encrypted message content by the internal archiving platform. In some embodiments, a user of computer terminal 136 may authenticate themselves with the archival logging function(s) 134, and based on their authentication credentials, they may be granted access to transmitted message data associated with a specified subscriber ID or set of subscriber IDs and diagnostic services of the archival logging function(s) 134. For example, in some embodiments, the authentication credentials may grant access to a set of transmitted message data corresponding to subscriber IDs associated with a specific archival partner ID and/or primary message archiving platform 142.

For example, in one use case example, the operator of a primary message archiving platform 142 may notify the messaging service platform operator for the IMS core 150 that one or more items of transmitted message data deposited for one or more of their associated subscriber IDs is non-passable and/or otherwise contains errors (e.g., formatting errors). The messaging service platform operator may update one or more subscriber archiving profiles 124 (in the message subscriber database 122) associated with subscriber IDs whose archive deposits are experiencing error, with an inspection indicator (as shown in FIG. 2) that triggers the message archive routing server 120 to deposit transmitted message data (which may include incoming and/or outgoing transmitted message data) to the internal archiving platform 130. The authorized staff member of the messaging service platform may then use the computer terminal 136 access functions and/or services of the archival logging function(s) 134 to evaluate the message content of one or more copies of transmitted message data deposited to the internal archiving platform 130, which should provide an exact representation of the transmitted message data that was, or would have been, deposited to the normally designated primary message archiving platform 142. Moreover, because the internal archiving platform 130 includes the internal message endpoint 132 that defines an authorized endpoint for the end-to-end encryption and authentication protocols, the archival logging function(s) 134 may execute the appropriate decryption to access the unencrypted message content of the deposited transmitted message data to perform debugging, troubleshooting, and/or auditing of the unencrypted message content. In some embodiments, transmitted message data may be routinely deposited to the internal archiving platform 130 in parallel with being deposited to the normally designated primary message archiving platform 142, and the archival logging function(s) 134 may proactively monitor for anomalies in the transmitted message data and trigger an alarm (e.g., to computer terminal 136) when anomalies are detected.

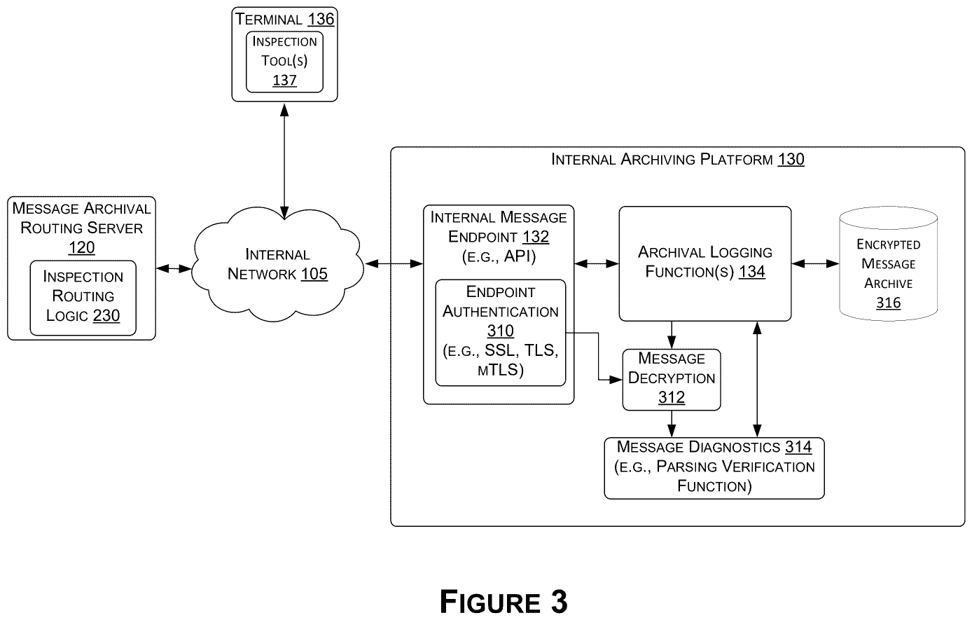

Referring now to FIG. 3, an example internal archiving platform 130 is shown in accordance with some embodiments. As previously discussed, the internal archiving platform 130 may comprise an internal message endpoint 132 and one or more archival logging functions 134. In some embodiments, the internal message endpoint 132 may comprise an API that mimics the functionality of the primary message archiving platform(s) 142 as authorized message endpoints. For example, in some embodiments, the internal message endpoint 132 may include an endpoint authentication 310 function that performs an SSL protocol handshake (and/or other end-to-end encryption and authentication protocols such as, but not limited to, SSL, TLS and/or mTLS) with the IMS core 150 and/or UE 110 of the MO. The one or more archival logging functions 134 may then receive the still encrypted transmitted message data from the internal message endpoint 132 and use one or more credentials derived by the endpoint authentication 310 to perform a message decryption 312 of the transmitted message data to obtain access to the unencrypted message content payload. The unencrypted message content payload may then be processed by one or more message diagnostics 314 (e.g., as selected by the messaging service platform via computer terminal 136) to perform debugging, troubleshooting, and/or auditing of the unencrypted message content. The results of the message diagnostics 314 may be communicated back to the messaging service platform (e.g., displayed to computer terminal 136) as reports and/or alarms.

For example, in some embodiments, the message diagnostics 314 may include an implementation of the parsing logic applied by a primary message archiving platform 142 to process deposited transmitted message data. As an example, the unencrypted message content of transmitted message data may comprise a comma-separated values (CSV) file (or other data structure) that the primary message archiving platform 142 expects to have a predefined format of data fields appearing in a given order. The message diagnostics 314 may include an algorithm programmed to parse the unencrypted message content based on the expected data structure ingesting and parsing the message content in the same way the primary message archiving platform 142 would ingest and parse the message content to validate that the content may be processed as expected. In some embodiments, the message diagnostics 314 may perform a very basic inspection of the message content to basically attempt to parse the content. If the message content parses correctly, then the message diagnostics 314 may send a positive response back to IMS core 150 via the message archival routing server. If the message content fails to parse, then message diagnostics 314 may send a negative response. That is, if the message diagnostics 314 determines that the data structure is mis-formatted as compared to the expected data structure or contains other errors, the message diagnostics 314 may cause the archival logging functions 134 to report such errors back to the messaging service platform troubleshooters. In some embodiments, the message diagnostics 314 may process the unencrypted message content of transmitted message data in real-time (e.g., as it is received by the internal archiving platform 130). In some embodiments, the archival logging functions 134 may store the encrypted transmitted message data to an encrypted message archive 316 (e.g., a database or other storage device). The archival logging functions 134 may then subsequently retrieve the encrypted transmitted message data from the encrypted message archive 316 for evaluation by the message diagnostics 314 in response to instructions received from the messaging service platform troubleshooters (e.g., instructions provided via the computer terminal 136). In some embodiments, the archival logging function(s) 134 may retrieve encrypted transmitted message data from the encrypted message archive 316, perform a message decryption 312, and transmit the unencrypted message content to the computer terminal 136 and/or one or more other network functions for further analysis.

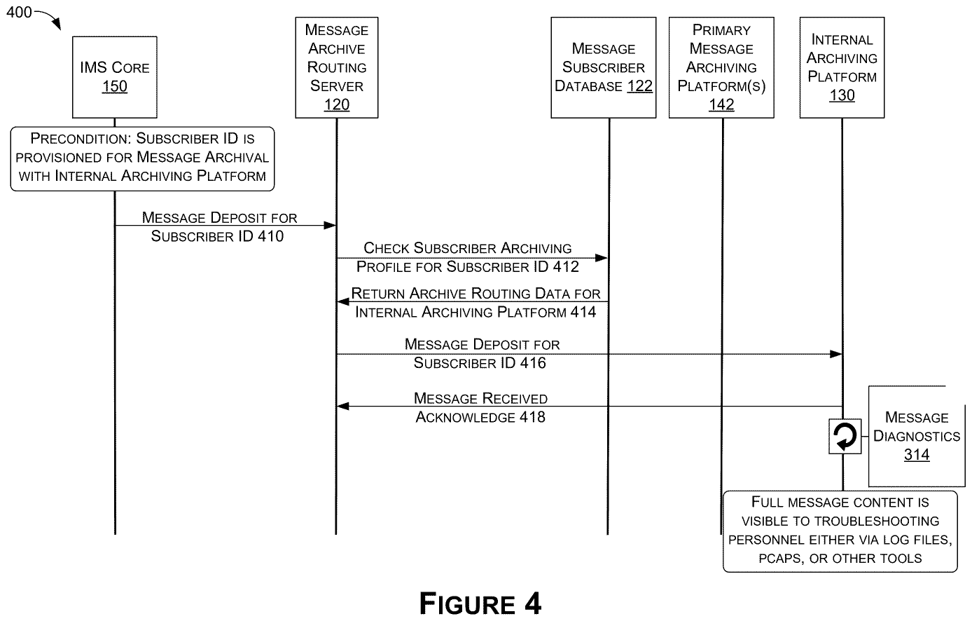

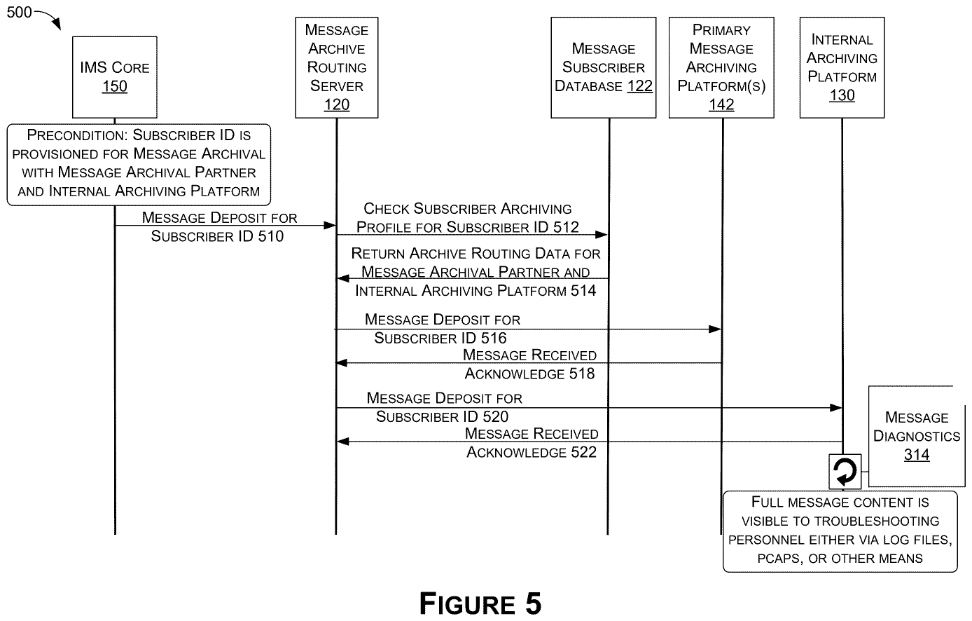

Now referring to FIG. 4, an example data flow 400 is illustrated representing an embodiment where an inspection indicator is included in a subscriber archiving profile to enable deposits to the internal archiving platform 130, where deposits to the normally designated primary message archiving platform 142 are suspended. Such a configuration may be used, for example, where a new messaging user (e.g., a new subscriber ID) has been commissioned, and the messaging service platform desires to perform testing of messaging archiving functions before permitting deposits to a primary message archiving platform 142, or where a primary message archiving platform 142 has authorized the messaging service platform to perform troubleshooting with test data that does not represent actual message data that should be archived. As discussed above, the subscriber archiving profile 124 for the subscriber ID under inspection may be modified (e.g., as shown at 224) to include the inspection indicator, and suspend the archival partner ID associated with the normally designated primary message archiving platform 142. In some embodiments, the message archive routing server 120 may interpret the presence of the inspection indicator in the subscriber archiving profile 124 as an instruction to suspend sending copies of the transmitted message data 205 to a normally designated primary message archiving platform 142 listed in the subscriber archiving profile 124. In some embodiments, the inspection indicator may selectively include an additional flag indicating whether the message archive routing server 120 is to suspend depositing copies of the transmitted message data 205 to the normally designated primary message archiving platform 142, or instead (as discussed below with respect to FIG. 5) continue to deposit copies of the transmitted message data 205 to the normally designated primary message archiving platform 142, in addition to depositing a copy to the internal archiving platform 130.

The internal archiving platform 130 may then begin receiving copies of the transmitted message data for the subscriber ID from the message archive routing server 120 as an approved endpoint (e.g., with an approved SSL connection). As shown at 410, the IMS core 150 may transmit a message deposit (e.g., a copy of the transmitted message data 205) associated with a subscriber ID to the message archive routing server 120. As noted in FIG. 4, a precondition is that the subscriber ID is provisioned for message archiving services with the internal archiving platform 130. Upon receiving the message deposit 410, the message archive routing server 120 may query the message subscriber database 122 to check the subscriber archiving profile 124 for the subscriber ID (shown at 412) and receive in return archive routing data for the internal archiving platform 130 as shown at 414 (e.g., a partner ID associated with the internal archiving platform 130). This query may be performed as previously explained with respect to FIG. 2 where the subscriber archiving profile 124 for the subscriber ID includes an inspection indicator as illustrated at 224 (e.g., where the archival partner ID is suspended). Having received the archive routing data for the internal archiving platform 130, the message archive routing server 120 may transmit the message deposit for the subscriber ID to the internal archiving platform 130, as shown at 416. In some embodiments, the internal archiving platform 130 may transmit a message received acknowledgement 418 (e.g., a 200 OK code message) back to the message archive routing server 120 to indicate receipt of the message deposit 416. With the copy of the transmitted message data successfully deposited with the internal archiving platform 130, one or more evaluations may be performed by message diagnostics 314 and/or other network functions (e.g., as explained with respect to FIG. 3). The full decrypted message content of the transmitted message data may be accessed from the internal archiving platform 130 where it may be made visible for troubleshooting either via log files, packet capture (PCAP), and/or other inspection and analysis tools.

Now referring to FIG. 5, an example data flow 500 is illustrated representing an embodiment where an inspection indicator is included in a subscriber archiving profile to enable deposits to the internal archiving platform 130 in addition to deposits to the normally designated primary message archiving platform 142. Such a configuration may be used, for example, to provide real-time feedback to the MO and/or the messaging service platform developers, where the internal archiving platform 130 may evaluate transmitted message data and send a message if the evaluation determines that the transition to the normally designated primary message archiving platform 142 might contain structural errors (e.g., may be corrupted and/or mis-formatted).

As discussed above, the subscriber archiving profile 124 for the subscriber ID under inspection may be modified (e.g., as shown at 222) to include the inspection indicator while further specifying the archival partner ID associated with the normally designated primary message archiving platform 142. The internal archiving platform 130 may then begin receiving copies of the transmitted message data for the subscriber ID from the message archive routing server 120 as an approved endpoint (e.g., with an approved SSL connection). As shown at 510, the IMS core 150 may transmit a message deposit (e.g., a copy of the transmitted message data 205) associated with a subscriber ID to the message archive routing server 120. As noted in FIG. 5, a precondition is that the subscriber ID is provisioned for message archiving services with the internal archiving platform 130. Upon receiving the message deposit 510, the message archive routing server 120 may query the message subscriber database 122 to check the subscriber archiving profile 124 for the subscriber ID (shown at 512) and receive in return archive routing data for the normally designated primary message archiving platform 142 and the internal archiving platform 130 as shown at 514 (e.g., a partner ID associated with the internal archiving platform 130 and a partner ID associated with a primary message archiving platform 142). This query may be performed as previously explained with respect to FIG. 2, where the subscriber archiving profile 124 for the subscriber ID includes an inspection indicator as illustrated at 224 in addition to the archival partner ID. Having received the archive routing data for the primary message archiving platform 142 and internal archiving platform 130, the message archive routing server 120 may transmit the message deposit to the primary message archiving platform 142 and the internal archiving platform 130. For example, as shown at 516, the message archive routing server 120 may transmit the message deposit for the subscriber ID to the primary message archiving platform 142. In some embodiments, the primary message archiving platform 142 may transmit a message received acknowledgement 518 (e.g., a 200 OK message) back to the message archive routing server 120 to indicate receipt of the message deposit 516. As shown at 520, the message archive routing server 120 may transmit the message deposit for the subscriber ID to the internal archiving platform 130. In some embodiments, the internal archiving platform 130 may transmit a message received acknowledgement 522 (e.g., a 200 OK message) back to the message archive routing server 120 to indicate receipt of the message deposit 520. With the copy of the transmitted message data successfully deposited with the internal archiving platform 130, one or more evaluations may be performed by message diagnostics 314 and/or other network functions (e.g., as explained with respect to FIG. 3). The full decrypted message content of the transmitted message data may be accessed from the internal archiving platform 130, where it may be made visible for troubleshooting either via log files, packet capture (PCAP), and/or other inspection and analysis tools. As such, the message deposit 520 of transmitted message data to the internal archiving platform 130 should essentially comprise an exact copy of the message deposit 516 of transmitted message data to the primary message archiving platform 142.

Referring now to FIG. 6, FIG. 6 is a diagram illustrating an example telecommunications network environment 600 implementing the messaging services described with respect to FIGS. 1-3, including the IMS core 150, message routing server 126, message archive routing server 120, message subscriber database 122, and/or internal archiving platform 130, implemented as network functions of an operator core network 650 and made available as network services. For example, in some embodiments, the message subscriber database 122 may respond to application programming interface (API) calls from a user (e.g., from a computer terminal 136) to reconfigure one or more subscriber archiving profiles 124 to activate the logging of copies of transmitted message data based on including and/or removing inspection indicators, and/or suspending partner IDs, as discussed with respect to FIG. 2 for example. In some embodiments, the internal archiving platform 130 may respond to application programming interface (API) calls from a user (e.g., from a computer terminal 136) to control one or more archival logging functions 134 and/or message diagnostics 314, as discussed with respect to FIG. 3 for example.

Network environment 600 is but one example of a suitable telecommunications network and is not intended to suggest any limitation as to the scope of use or functionality of the embodiments disclosed herein, and nor should the network environment be interpreted as having any dependency or requirement relating to any one or combination of components illustrated. As shown in FIG. 6, network environment 600 comprises an operator core network 650 (also referred to as a “core network”) that provides one or more network services to one or more UEs (such as UEs 110) via at least one access network 602 (e.g., a radio access network (RAN)). In some embodiments, network environment 600 comprises, at least in part, a wireless communications network, such as, but not limited to, a 4G wireless communications network and/or a 5G wireless communications network. In some embodiments, the access network(s) 602 of network environment 600 comprises one or more RANs, which may be referred to in the context of a wireless telecommunications network as a wireless base station, cell site, or cellular base station. At least one RAN may represent at least one wireless base station coupled to the operator core network 650 to establish one or more communication links between the operator core network 650 and UE 110. Each RAN may provide wireless connectivity access to one or more UEs 110 operating within one or more coverage areas associated with a particular RAN. The RAN may implement wireless connectivity using, for example, 3rd Generation Partnership Project (3GPP) technologies. The one or more of the access network(s) 602 may be referred to as an eNodeB in the context of a 4G Long-Term Evolution (LTE) implementation, a gNodeB in the context of a 5G New Radio (NR) implementation, or other terminology depending on the specific implementation technology. In some embodiments, access networks 602 may comprise, at least in part, components of a customer premises network, such as a distributed antenna system (DAS), for example, or other similar customer premises equipment (CPE). When an access network 602 is implemented as a RAN, the RAN may comprise a multimodal network (for example, comprising one or more multimodal access devices) where multiple radios supporting different systems are integrated into the RAN. Such a multimodal access network may support a combination of 3GPP radio technologies (e.g., 4G, 5G, and/or 6G) and/or non-3GPP radio technologies (e.g., Institute of Electrical and Electronics Engineers (IEEE) 802.11 (WiFi) and/or IEEE 802.15 (Bluetooth) access points). In some embodiments, access network(s) 602 may comprise a terrestrial wireless communications base station and/or may be at least in part implemented as a space-based access network, such as a base station implemented by an Earth-orbiting satellite. Individual UEs 110 may communicate with the operator core network 650 via the access network(s) 602 over one or both of uplink (UL) radio frequency (RF) signals and downlink (DL) radio frequency (RF) signals.

As shown in FIG. 6, access networks 602 may be coupled to the operator core network 650 via a core network edge 611 that comprises one or more edge server nodes 630 and wired and/or wireless network connections that may further include wireless relays and/or repeaters. In some embodiments, the access networks 602 may be coupled to the operator core network 650 at least in part by a backhaul network such as the Internet or other public or private network infrastructure.

Core network edge 611 may comprise one or more network nodes (e.g., servers) or other elements of the operator core network 650 that may define the boundary of the operator core network 650 and may serve as the architectural demarcation point where the operator core network 650 connects to other networks such as, but not limited to, access networks 602, the Internet, a Data Network (DN) 607, and/or other third-party networks. In some embodiments, DN 607 may include one or more data stores and/or one or more cloud-based servers such that UE 110 may access services and/or content provided by the data store(s) and/or server(s) of DN 607. In some embodiments, one or more of the primary message archiving platform(s) 142 may be network nodes or elements within the DN 607 and/or may be coupled to the operator core network 650 at least in part by a backhaul network such as the Internet or other public or private network infrastructure.

In some embodiments, the network edge 611 may comprise one or more network nodes that include at least one edge server 630 that hosts an internal archiving platform 130 as discussed herein. As such, the internal archiving platform 130, as well as transmitted message data sent and deposited to the internal archiving platform 130, may remain within the trusted bounds of the operator core network 650 and/or core network edge 611 of the operator core network 650. In some embodiments, one or more edge server(s) 630 may provide, for example, edge-based network function services to UEs 110 that may be accessed separately from services provided by network functions of the operator core network 650. For example, edge server(s) 630 may host databases, caches, microservices, ledgers, decentralized applications (e.g., DApps), and/or may perform data traffic monitoring, inspections, and/or aggregation for other network functions of the network environment 600.

It should be understood that in some embodiments, the network environment 600 may not comprise a distinct operator core network 650, but rather may implement one or more features of the operator core network 650 within other portions of the network, or may not implement them at all, depending on various carrier preferences. In some implementations, the operator core network 650 may comprise modules, also referred to as network functions (NFs), implemented by one or more processors and generally represented in FIG. 6 as NF(s) 640. Such network functions 640 may include one or more of, but are not limited to, a core access and mobility management function (AMF), an access network discovery and selection policy (ANDSP), an authentication server function (AUSF), a user plane function (UPF), non-3GPP interworking function (N3IWF), a session management function (SMF), a network slice selection function (NSSF), a policy control function (PCF), a unified data management (UDM) function, a unified data repository (UDR), an unstructured data storage function (UDSF), a network data analytics function (NWDAF), a network exposure function (NEF), an operations support system (OSS), and/or other network functions. In some embodiments, the Operator Core Network 650 and/or IMS core 150 may comprise other network functions such as, but not limited to, a home subscriber server (HSS) and/or or user profile server function (UPSF). The HSS and/or UPSF may comprise a user database (e.g., subscriber IDs and/or partner IDs) that supports the IMS network entities that actually handle calls between UEs 110. In some embodiments, the database may include subscription-related information (subscriber profiles), that is used to perform authentication and authorization of users, and can provide information about the subscriber's location and IP information.

The internal archiving platform 130, which may be hosted on one or more edge servers 630 and/or other server nodes of the operator core network 650, may be implemented as a containerized function within the telecommunications network environment 600 (e.g., as illustrated in FIG. 9) as an internal service or endpoint, to replicate what a primary message archiving platform 142 endpoint would do with respect to receiving deposits of transmitted message data (e.g., establish a secure connection with the message archive routing server 120 to ingest message archival content.

Implementation of these NFs 640 of the operator core network 650 may be executed by one or more controllers 654 on which these network functions are orchestrated or otherwise configured to execute utilizing processors and memory of the one or more controllers 654. The NFs may be implemented as physical and/or virtual network functions, container network functions, and/or cloud-native network functions, such as is described with respect to FIG. 9.

The user plane function (UPF), illustrated in FIG. 6 at 642, represents at least one function of the operator core network 650 that may extend into the core network edge 611. In some embodiments, the access network 602 is coupled to the UPF 642 within the core network edge 611 by a communication link that includes an N3 user plane tunnel 608. For example, the N3 user plane tunnel 608 may connect a cell site router of the access network 602 to an N3 interface of the UPF 642. In some embodiments, transmitted message data as discussed herein may be communicated between UEs 110 and components of the operator core network 650 through the N3 user plane tunnel 608. The data store(s), server(s), and/or other elements of DN 607 (including, for example, primary message archiving platform(s) 142) may be coupled to the UPF 642 in the core network edge 611 by an N6 user plane tunnel 609. For example, the N6 user plane tunnel 609 may connect a network interface (e.g., a switch, router, and/or gateway) of the DN 607 to an N6 interface of the UPF 642. In some embodiments, transmitted message data as discussed herein may be communicated between message archive routing server 120 and the primary message archiving platform(s) 142 through the N6 user plane tunnel 609. In some embodiments, the operator core network 650 may comprise a plurality of UPFs 642, such as a UPF at the operator core network 650 and a UPF at the core network edge 611. For example, a UPF at the core network edge 611 may be used for local breakout and/or low-latency types of applications via an N9 interface between the distinct UPFs.

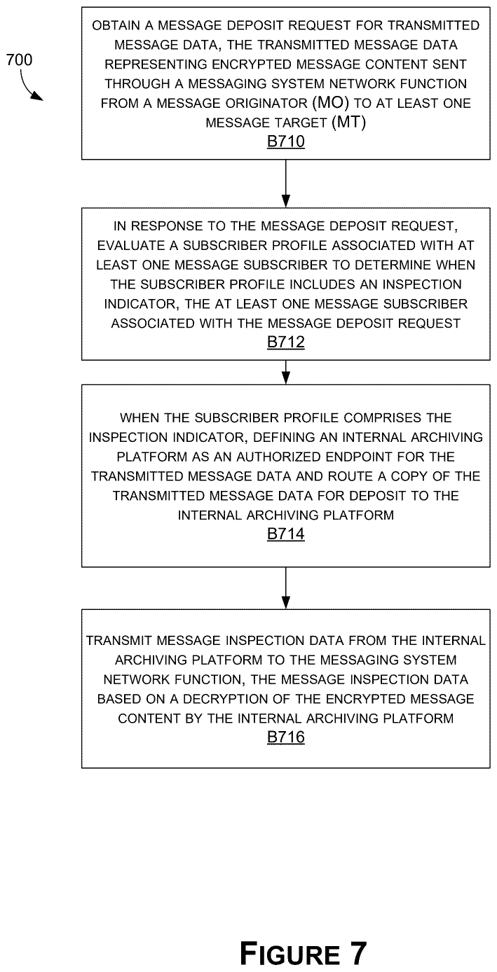

FIG. 7 is a flow chart illustrating a method 700 for archival message content inspection for encrypted messaging, according to some embodiments. It should be understood that the features and elements described herein with respect to the method of FIG. 7 may be used in conjunction with, in combination with, or substituted for elements of any of the other embodiments discussed herein and vice versa. Further, it should be understood that the functions, structures, and other descriptions of elements for embodiments described in FIG. 7 may apply to like or similarly named or described elements across any of the figures and/or embodiments described herein and vice versa. In some embodiments, elements of method 700 are implemented utilizing one or more processing units comprising processing circuitry, such as the controller of an operator core network, a network node, a networked server, an edge server, an access network, a RAN, user equipment (UE), a computing device, a cloud computing environment, and/or other processing units or computing devices as disclosed in any of the embodiments herein. In some embodiments, the method 700 may be implemented by components of a telecommunications network environment 600, such as illustrated by FIG. 6.

The method 700, at B710, includes obtaining a message deposit request for transmitted message data, the transmitted message data representing encrypted message content sent through a messaging system network function from a message originator (MO) to at least one message target (MT). In some embodiments, the messaging system network function may comprise an IP Multimedia Subsystem (IMS) core of a telecommunications network. As discussed herein with respect to FIG. 1, an operating environment 100 may comprise an IP Multimedia Core Network Subsystem (IMS) core 150 that operates as a standardized architectural framework for a messaging system that facilitates the delivery of messages between an MO and one or more MTs over a network (e.g., IP networks such as the Internet). The IMS core 150 may manage session control, authentication, and authorization, enabling users to access messaging services (e.g., Short Message Service (SMS), Multimedia Messaging Service (MMS), Rich Communication Services (RCS), Unstructured Supplementary Service Data (USSD) and/or other message exchange services) securely and efficiently. The IMS core 150 may also support interoperability between various service providers (e.g., such as but not limited to the session initiation protocol (SIP), allowing for a consistent user experience regardless of the underlying network infrastructure. By leveraging protocols like SIP (Session Initiation Protocol), the IMS core 150 ensures robust and scalable communication, making it a vital element in modern telecommunications. In some embodiments, the IMS core 150 may be implemented as a component network function of a telecommunications network operator core network (CN) 650 such as shown and discussed below with respect to FIG. 6. With respect to messaging services, the IMS core 150 may function to transmit messages from user equipment (UE) 110 operating as the MO to one or more message targets (MT) UE 110, operating as the MT(s).

The method 700, at B712, includes, in response to the message deposit request, evaluating a subscriber profile associated with at least one message subscriber to determine when the subscriber profile includes an inspection indicator, the at least one message subscriber associated with the message deposit request. For example, as illustrated in FIG. 2, in some embodiments the IMS core 150 may send a copy of the transmitted message data 205 (which carries the encrypted message content payload) to the message archive routing server 120. The message archive routing server 120 may respond to receiving the transmitted message data 205 by sending an archive routing query 210 to the message subscriber database 122 based on a subscriber ID (e.g., of the MO) included with the copy of the transmitted message data 205. The message subscriber database 122 may include one or more subscriber archiving profiles 124, as shown at 124. In some embodiments, the message subscriber database 122 may be integrated within the message archive routing server 120. The inspection indicator of the subscriber profile may be configured to control activation of the routing of the copy of the transmitted message data for deposit to the internal archiving platform. In some embodiments, an individual subscriber archiving profile (shown by example at 220, 222, 224, and 226) may be defined for a subscriber ID that identifies one or partner IDs corresponding to a respective primary message archiving platform 142 where a copy of the transmitted message data 205 should be deposited.

The method 700, at B714, includes, when the subscriber profile comprises the inspection indicator, defining an internal archiving platform as an authorized endpoint for the transmitted message data and routing a copy of the transmitted message data for deposit to the internal archiving platform. That is, in some embodiments, in order to deposit the transmitted message data 205 for a subscriber ID to the internal archiving platform 130, the subscriber archiving profile 124 associated with that subscriber ID may be updated (e.g., configured using inspection tool 137) to include an inspection indicator, as shown in FIG. 2 at 222 and 224. The copy of the transmitted message data for deposit to the internal archiving platform may be routed to the internal archiving platform by a message archive routing server of the messaging system network function. The transmitted message data for deposit to the internal archiving platform may be deposited to the internal archiving platform based on an encryption and authentication protocol based at least on one or more of: secure sockets layer (SSL), transport layer security (TLS), or mutual transport layer security (mTLS). In some embodiments, the the internal archiving platform may be implemented by an edge server of a core network edge of a telecommunications network. The ability to reconfigure the subscriber archiving profile 224 permits the operator of the messaging system to gain access to inspect the contents of transmitted message data 205 by inserting the inspection indicator-which functions to establish the internal archiving platform 130 as a simulated authorized endpoint for receiving the transmitted message data 205 and thus provides the ability to messaging service platform developers and system administrators to access the message content payload in an unencrypted form, without compromising existing end-to-end messaging security protocols that protect the transmitted message data 205 between the MO and MT(s) and/or the MO and primary message archiving platforms 142. By capturing the raw data of the message content, developers can analyze the content and identify any discrepancies or errors that may be occurring.

In some embodiments a second copy of the transmitted message data may be routed for deposit to a primary message archiving platform based on an identification associated with the primary message archiving platform included in the subscriber profile. The copy of the transmitted message data may be routed for deposit to the internal archiving platform and route the second copy of the transmitted message data for deposit to the primary message archiving platform. In some embodiments, the subscriber profile may be updated (e.g., configured using inspection tool 137) to suspend routing of the second copy of the transmitted message data for deposit to the primary message archiving platform based at least on the inspection indicator. As discussed above, when an inspection indicator is included in the subscriber archiving profile 124 for a subject ID, the profile may be configured to deposit the copy of transmitted message data 205 to both the normally designated primary message archiving platform 142 and the internal archiving platform 130, or to deposit the copy of transmitted message data 205 to the internal archiving platform 130 instead of the normally designated primary message archiving platform 142 (e.g., by flagging the partner ID for the normally designated primary message archiving platform 142 as suspended). By designating that the message archive routing server 120 should deposit the copy of transmitted message data 205 to the internal archiving platform 130, each of the MO and the internal archiving platform 130 represents an endpoint of the message transmission with end-to-end encryption and authentication protocols (e.g., SSL, TLS, and/or mTLS) applied between those endpoints. As an authorized endpoint for the transmitted message data, the internal archiving platform 130 is able to decrypt and inspect the message content payload of the transmitted message data to provide the messaging service platform developers and system administrators with access to the original message payload using the same credentials and protocol as any other primary message archiving platform 142 would use to receive and archive the copy of the transmitted message data 205. The transmitted message data deposited to the internal archiving platform 130 has traveled as traffic through a substantially similar path through the production environment as transmitted message data 205 deposited with the message archive partner(s) 142—providing very close visibility into exactly what these message archive partner(s) and/or customers of the messaging service are seeing—without compromising endpoint-to-endpoint security.

In some embodiments, the messaging system network function transports the transmitted message data between the message originator (MO), the at least one message target (MT), and the internal archiving platform, based at least on one or more of Short Message Service (SMS), Multimedia Messaging Service (MMS), Rich Communication Services (RCS), or Unstructured Supplementary Service Data (USSD). For example, the IMS core 150 may manage session control, authentication, and authorization, enabling users to access messaging services (e.g., Short Message Service (SMS), Multimedia Messaging Service (MMS), Rich Communication Services (RCS), Unstructured Supplementary Service Data (USSD) and/or other message exchange services) securely and efficiently.

The method 700, at B716, includes, transmitting message inspection data from the internal archiving platform to the messaging system network function, the message inspection data based on a decryption of the encrypted message content by the internal archiving platform. In some embodiments, the encrypted message content may be decrypted using authentication credentials obtained based on the encryption and authentication protocol. For example, one or more archival logging functions 134 may receive the still encrypted transmitted message data from the internal message endpoint 132 and use one or more credentials derived by the endpoint authentication 310 to perform a message decryption 312 of the transmitted message data to obtain access to the unencrypted message content payload. The unencrypted message content payload may then be processed by one or more message diagnostics 314 (e.g., as selected by the messaging service platform via computer terminal 136) to perform debugging, troubleshooting, and/or auditing of the unencrypted message content. The results of the message diagnostics 314 may be communicated back to the messaging service platform (e.g., displayed to computer terminal 136) as reports and/or alarms.

In some embodiments, message inspection data may be based at least on a parsing verification performed by the internal archiving platform on the copy of the transmitted message data. As discussed with respect to FIG. 3, the unencrypted message content payload may then be processed by one or more message diagnostics 314 (e.g., as selected by the messaging service platform via computer terminal 136) to perform debugging, troubleshooting, and/or auditing of the unencrypted message content. The results of the message diagnostics 314 may be communicated back to the messaging service platform (e.g., displayed to computer terminal 136) as reports and/or alarms. For example, in some embodiments, the message diagnostics 314 may include an implementation of the parsing logic applied by a primary message archiving platform 142 to process deposited transmitted message data. As an example, the unencrypted message content of transmitted message data may comprise a comma-separated values (CSV) file (or other data structure) that the primary message archiving platform 142 expects to have a predefined format of data fields appearing in a given order. The message diagnostics 314 may include an algorithm programmed to parse the unencrypted message content based on the expected data structure ingesting and parsing the message content in the same way the primary message archiving platform 142 would ingest and parse the message content to validate that the content may be processed as expected. In some embodiments, the message diagnostics 314 may perform a very basic inspection of the message content to basically attempt to parse the content. If the deposited message content parses correctly, then the message diagnostics 314 may send a positive response back to IMS core 150 via the message archival routing server. If the message content fails to parse, then message diagnostics 314 may send a negative response. That is, if the message diagnostics 314 determine that the data structure is mis-formatted as compared to the expected data structure or contains other errors, the message diagnostics 314 may cause the archival logging functions 134 to report such errors back to the messaging service platform troubleshooters. In some embodiments, the message diagnostics 314 may process the unencrypted message content of transmitted message data in real-time (e.g., as it is received by the internal archiving platform 130). In some embodiments, the archival logging functions 134 may store the encrypted transmitted message data to an encrypted message archive 316 (e.g., a database or other storage device). The archival logging functions 134 may then subsequently retrieve the encrypted transmitted message data from the encrypted message archive 316 for evaluation by the message diagnostics 314 in response to instructions received from the messaging service platform troubleshooters (e.g., instructions provided via the computer terminal 136). In some embodiments, the archival logging function(s) 134 may retrieve encrypted transmitted message data to an encrypted message archive 316 from the encrypted message archive 316, perform a message decryption 312, and transmit the unencrypted message content to the computer terminal 136 and/or one or more other network functions for further analysis.

Referring to FIG. 8, a diagram is depicted of an exemplary computing environment suitable for use in implementations of the present disclosure. In particular, the exemplary computer environment is shown and designated generally as computing device 800. Computing device 800 is but one example of a suitable computing environment and is not intended to suggest any limitation as to the scope of use or functionality of the embodiments described herein, and nor should computing device 800 be interpreted as having any dependency or requirement relating to any one or combination of components illustrated. In various embodiments, one or more aspects of a message routing server 126, a message archive routing server 120, a message subscriber database 122, an internal archiving platform 130 and/or a computing device 136, as described herein, may be implemented at least in part using a computing device 800.

The implementations of the present disclosure may be described in the general context of computer code or machine-useable instructions, including computer-executable instructions such as program components, being executed by a computer or other machine, such as a personal data assistant or other handheld device. Generally, program components, including routines, programs, objects, components, data structures, and the like, refer to code that performs particular tasks or implements particular abstract data types. Implementations of the present disclosure may be practiced in a variety of system configurations, including handheld devices, consumer electronics, general-purpose computers, specialty computing devices, etc. Implementations of the present disclosure may also be practiced in distributed computing environments where tasks are performed by remote-processing devices that are linked through a communications network.

With continued reference to FIG. 8, computing device 800 includes bus 810 that directly or indirectly couples the following devices: memory 812, one or more processors 814, one or more presentation components 816, input/output (I/O) ports 818, I/O components 820, power supply 822, and radio 824. Bus 810 represents what may be one or more buses (such as an address bus, data bus, or combination thereof). The devices of FIG. 8 are shown with lines for the sake of clarity. However, it should be understood that the functions performed by one or more components of the computing device 800 may be combined or distributed amongst the various components. For example, a presentation component such as a display device may be one of I/O components 820. In some embodiments, one or more functions of one or more aspects of a message routing server 126, a message archive routing server 120, a message subscriber database 122, an internal archiving platform 130 and/or a computing device 136, as described herein may be executed at least in part by computing device 800. The processors 814 of computing device 800 may include a memory. The present disclosure hereof recognizes that such is the nature of the art, and reiterates that FIG. 8 is merely illustrative of an exemplary computing environment that can be used in connection with one or more implementations of the present disclosure. Distinction is not made between such categories as “workstation,” “server,” “laptop,” “handheld device,” “smart television,” etc., as all are contemplated within the scope of FIG. 8 and refer to “computer” or “computing device.”

Computing device 800 typically includes a variety of one or more computer-readable media storing computer-usable instructions. For example, applications, algorithms, and/or neural networks may be stored in a memory comprising such computer-readable media. Computer-readable media can be any available media that can be accessed by computing device 800 and includes both volatile and non-volatile media, removable and non-removable media. By way of example, and not limitation, computer-readable media may comprise computer storage media and communication media. Computer storage media includes both volatile and non-volatile, removable and non-removable media implemented in any method or technology for storage of information such as computer-readable instructions, data structures, program modules, or other data.

Computer storage media includes non-transient random-access memory (RAM), read-only memory (ROM), electrically erasable programmable read-only memory (EEPROM), flash memory or other memory technology, compact disk (CD)-ROM, digital versatile disks (DVDs) or other optical disk storage, magnetic cassettes, magnetic tape, magnetic disk storage, or other magnetic storage devices. Computer storage media and computer-readable media do not comprise a propagated data signal or signals per se.

Communication media typically embodies computer-readable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, radio frequency (RF), infrared, and other wireless media. Combinations of any of the above should also be included within the scope of computer-readable media.

Memory 812 includes computer storage media in the form of volatile and/or non-volatile memory. Memory 812 may be removable, non-removable, or a combination thereof. Exemplary memory includes solid-state memory, hard drives, optical-disc drives, etc. Computing device 800 includes one or more processors 814 that comprise processing circuitry and that read data from various entities such as bus 810, memory 812, and/or I/O components 820. Processors 814 may include one or more central processing units (CPUs) 826 and/or one or more graphics processing units (GPUs) 828. In some embodiments, one or more functions of one or more aspects of a message routing server 126, a message archive routing server 120, a message subscriber database 122, an internal archiving platform 130 and/or a computing device 136, as described herein, may include software code executed on CPUs 826 and/or GPUs 828. One or more presentation components 816 present data indications to a person or other device. Exemplary one or more presentation components 816 include a display device, speaker, printing component, vibrating component, etc. I/O ports 818 allow computing device 800 to be logically coupled to other devices including I/O components 820, some of which may be built into computing device 800. Illustrative I/O components 820 include a microphone, joystick, game pad, satellite dish, scanner, printer, wireless device, etc. In some embodiments, the I/O components 820 may include a network interface card (NIC) for coupling to a network, such as is described herein.

Radio(s) 824 represents a radio that facilitates communication with a wireless telecommunications network (such as telecommunications network 600). For example, radio(s) 824 may be used to establish communications with components of an access network 602, operator core network 650, and/or core network edge 611. Illustrative wireless telecommunications technologies include code-division multiple access (CDMA), general packet radio service (GPRS), time-division multiple access (TDMA), global system for mobile communications (GSM), and the like. Radio(s) 824 may additionally or alternatively facilitate other types of wireless communications including Wi-Fi, WiMAX, LTE, and/or other voice-over-internet protocol (VoIP) communications. In some embodiments, radio(s) 824 may support multimodal connections that include a combination of 3GPP radio technologies (e.g., 4G, 5G, and/or 6G) and/or non- 3GPP radio technologies. As can be appreciated, in various embodiments, radio(s) 824 can be configured to support multiple technologies, and/or multiple radios can be utilized to support multiple technologies. In some embodiments, the radio(s) 824 may support communicating with an access network comprising a terrestrial wireless communications base station and/or a space-based access network (e.g., an access network comprising a space-based wireless communications base station). A wireless telecommunications network might include an array of devices, which are not shown so as to not obscure more relevant aspects of the embodiments described herein. Components such as a base station, a communications tower, or even access points (as well as other components) can provide wireless connectivity in some embodiments.

Referring to FIG. 9, a diagram is depicted generally at 900 of an exemplary cloud computing environment 910 for implementing one or more aspects of multi-session agent authentication for accessing data records, as implemented by the systems and methods described herein. Cloud computing environment 910 is but one example of a suitable cloud computing environment and is not intended to suggest any limitation as to the scope of use or functionality of the embodiments presented herein, and nor should cloud computing environment 910 be interpreted as having any dependency or requirement relating to any one or combination of components illustrated. In some embodiments, the cloud computing environment 910 is coupled to a network 905 (e.g., network 105) and/or may be executed within operator core network 650, the core network edge 611, edge server 630, or otherwise coupled to the core network edge 611 or operator core network 650.

Cloud computing environment 910 includes one or more controllers 920 comprising one or more processors and memory. The controllers 920 may comprise servers of a data center. In some embodiments, the controllers 920 are programmed to execute code to implement at least one or more aspects of network operating environment 100 and/or telecommunications network environment 600 as described herein. For example, in one embodiment a network function for a message archive routing server 120, and/or an internal archiving platform 130 as discussed herein may be implemented as one or more virtual network functions (VNFs) 930 (which may include one or more container network functions (CNFs) running on a worker node cluster 925 established by the controllers 920.

The cluster of worker nodes 925 may include one or more orchestrated Kubernetes (K8s) pods that realize one or more containerized applications 935. In other embodiments, another orchestration system may be used. For example, the worker nodes 925 may use lightweight Kubernetes (K3s) pods, Docker Swarm instances, and/or other orchestration tools. In some embodiments, one or more elements of the environment 100 may be implemented by, or coupled to, the controllers 920 of the cloud computing environment 910 by network 105, operator core network 650, and/or core network edge 611. In some embodiments, one or more elements of a message subscriber database 122 and/or encrypted message archive 316 of an internal archiving platform 130 may be implemented at least in part using one or more data store persistent volumes 940 in the cloud computing environment 910.

In various alternative embodiments, system and/or device elements, method steps, or example implementations described throughout this disclosure (such as the UE, network nodes, servers, access networks, core network edge, operator core network, network functions, archive platforms, and/or any of the sub-parts thereof, for example) may be implemented at least in part using one or more computer systems, field-programmable gate arrays (FPGAs), application-specific integrated circuits (ASICs), or similar devices comprising a processor coupled to a memory and executing code to realize the elements and/or processes, said code stored on a non-transient hardware data storage device. Therefore, other embodiments of the present disclosure may include elements comprising program instructions resident on computer-readable media that when implemented by such computer systems enable them to implement the embodiments described herein. As used herein, the term “computer-readable media” refers to tangible memory storage devices having non-transient physical forms. Such non-transient physical forms may include computer memory devices, such as but not limited to: punch cards, magnetic disk or tape, any optical data storage system, flash read-only memory (ROM), non-volatile ROM, programmable ROM (PROM), erasable-programmable ROM (E-PROM), random-access memory (RAM), or any other form of permanent, semi-permanent, or temporary memory storage system of a device having a physical, tangible form. Program instructions include, but are not limited to, computer-executable instructions executed by computer system processors and hardware description languages such as Verilog or Very High-Speed Integrated Circuit (VHSIC) Hardware Description Language (VHDL).

As used herein, the terms “network function,” “framework,” “processor,” “controller,” “unit,” “model,” “core,” “server,” “node,” “module,” and similar phrases are used to describe computer processing components (e.g., processing circuitry) and/or one or more computer-executable services being executed on one or more computer processing components. In the context of this disclosure, such terms used in this manner would be understood by one skilled in the art to refer to specific network and/or computing elements and are not used as nonce word or intended to invoke 35 U.S.C. 112(f).

Many different arrangements of the various components depicted, as well as components not shown, are possible without departing from the scope of the claims below. Embodiments in this disclosure are described with the intent to be illustrative rather than restrictive. Alternative embodiments will become apparent to readers of this disclosure after and because of reading it. Alternative means of implementing the aforementioned can be completed without departing from the scope of the claims below. Certain features and subcombinations are of utility and may be employed without reference to other features and subcombinations and are contemplated within the scope of the claims.

In the preceding detailed description, reference is made to the accompanying drawings, which form a part hereof wherein like numerals designate like parts throughout, and in which is shown, by way of illustration, embodiments that may be practiced. It is to be understood that other embodiments may be utilized and structural or logical changes may be made without departing from the scope of the present disclosure. Therefore, the preceding detailed description is not to be taken in the limiting sense, and the scope of embodiments is defined by the appended claims and their equivalents.

What is claimed is:

1. A system comprising:
one or more processors; and
one or more computer-readable media storing computer-usable instructions that, when executed by the one or more processors, cause the one or more processors to:
obtain a message deposit request for transmitted message data, the transmitted message data representing encrypted message content sent through a messaging system network function from a message originator (MO) to at least one message target (MT);
in response to the message deposit request, evaluate a subscriber profile associated with at least one message subscriber to determine when the subscriber profile includes an inspection indicator, the at least one message subscriber associated with the message deposit request;
when the subscriber profile comprises the inspection indicator, define an internal archiving platform as an authorized endpoint for the transmitted message data and route a copy of the transmitted message data for deposit to the internal archiving platform; and
transmit message inspection data from the internal archiving platform to the messaging system network function, the message inspection data based on a decryption of the encrypted message content by the internal archiving platform.

2. The system of claim 1, wherein the messaging system network function comprises an IP Multimedia Subsystem (IMS) core of a telecommunications network.

3. The system of claim 1, wherein the copy of the transmitted message data for deposit to the internal archiving platform is routed to the internal archiving platform by a message archive routing server of the messaging system network function.

4. The system of claim 1, wherein transmitted message data for deposit to the internal archiving platform is deposited to the internal archiving platform based on an encryption and authentication protocol based at least on one or more of: secure sockets layer (SSL), transport layer security (TLS), or mutual transport layer security (mTLS).

5. The system of claim 4, wherein the one or more processors are further to decrypt the encrypted message content using authentication credentials obtained based on the encryption and authentication protocol.

6. The system of claim 1, wherein the internal archiving platform is implemented by an edge server of a core network edge of a telecommunications network.

7. The system of claim 1, wherein the one or more processors are further to configure the inspection indicator of the subscriber profile to control activation of the routing of the copy of the transmitted message data for deposit to the internal archiving platform.

8. The system of claim 1, wherein the one or more processors are further to route a second copy of the transmitted message data for deposit to a primary message archiving platform based on an identification associated with the primary message archiving platform included in the subscriber profile.

9. The system of claim 8, wherein the one or more processors are further to route the copy of the transmitted message data for deposit to the internal archiving platform and route the second copy of the transmitted message data for deposit to the primary message archiving platform.

10. The system of claim 8, wherein the one or more processors are further to update the subscriber profile to suspend routing of the second copy of the transmitted message data for deposit to the primary message archiving platform based at least on the inspection indicator.

11. The system of claim 1, wherein the messaging system network function transports the transmitted message data between the message originator (MO), the at least one message target (MT), and the internal archiving platform, based at least on one or more of Short Message Service (SMS), Multimedia Messaging Service (MMS), Rich Communication Services (RCS), or Unstructured Supplementary Service Data (USSD).

12. The system of claim 1, wherein message inspection data is based at least on a parsing verification performed by the internal archiving platform on the copy of the transmitted message data.

13. A telecommunications network, the network comprising:
an operator core network comprising an IP Multimedia Subsystem (IMS) core;
an internal archiving platform coupled to the IMS core; and
a message archive routing server coupled to the operator core network, wherein the message archive routing server executes operations to:
obtain a message deposit request from the IMS core for transmitted message data, the transmitted message data representing encrypted message content sent through the IMS core from a message originator (MO) to at least one message target (MT);
in response to the message deposit request, evaluate a subscriber profile associated with the transmitted message data;
route a copy of the transmitted message data for deposit to the internal archiving platform based on a determination that the subscriber profile associated with the transmitted message data comprises an inspection indicator, wherein the internal archiving platform comprises an authorized endpoint for the transmitted message data; and
wherein the internal archiving platform executes operations to:
output message inspection data to the IMS core, the message inspection data based on a decryption of the encrypted message content by the internal archiving platform.

14. The network of claim 13, wherein transmitted message data for deposit to the internal archiving platform is deposited to the internal archiving platform based on an encryption and authentication protocol based at least on one or more of: secure sockets layer (SSL), transport layer security (TLS), or mutual transport layer security (mTLS).

15. The network of claim 13, wherein the message archive routing server executes further operations to route a second copy of the transmitted message data for deposit to a primary message archiving platform based on an identification associated with the primary message archiving platform included in the subscriber profile.

16. The network of claim 15, wherein the IMS core is configured to update the subscriber profile to suspend routing of the second copy of the transmitted message data for deposit to the primary message archiving platform based at least on the inspection indicator.

17. The network of claim 13, wherein message inspection data is based at least on a parsing verification performed by the internal archiving platform on the copy of the transmitted message data.

18. A method comprising:
obtaining a message deposit request for transmitted message data, the transmitted message data representing encrypted message content sent through a messaging system network function from a message originator (MO) to at least one message target (MT);
in response to the message deposit request, evaluating a subscriber profile associated with at least one message subscriber to determine when the subscriber profile includes an inspection indicator, the at least one message subscriber associated with the transmitted message data;
routing a copy of the transmitted message data for deposit to an internal archiving platform based on a determination that the subscriber profile associated with the transmitted message data comprises an inspection indicator, wherein the internal archiving platform comprises an authorized endpoint for the transmitted message data; and
transmitting message inspection data from the internal archiving platform to the messaging system network function, the message inspection data based on a decryption of the encrypted message content by the internal archiving platform.

19. The method of claim 18, the method further comprising:
transmitting the copy of the transmitted message data for deposit to the internal archiving platform based on an encryption and authentication protocol based at least on one or more of: secure sockets layer (SSL), transport layer security (TLS), or mutual transport layer security (mTLS).

20. The method of claim 18, the method further comprising:
configuring the subscriber profile to suspend routing of a second copy of the transmitted message data to a primary message archiving platform when the subscriber profile includes the inspection indicator.
